(19) United States
(12) Patent Application Publication
(10) Pub. No.: US 2004/0153358 A1
(43) Pub. Date: Aug. 5, 2004

(54) Method and system for prioritizing user feedback

(76) Inventor: Deborah A. Lienhart, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/356,408

(22) Filed: Jan. 31, 2003

(51) Int. Cl. G06F 17/60

(52) U.S. Cl. 705/10

(57) ABSTRACT

A method and system for prioritizing user feedback is disclosed. In one method embodiment, a first feedback is received from a user. This embodiment of the present invention then assigns a value of the first feedback. In addition, the present embodiment assigns a rating to the user based on the value of the first feedback. In so doing, when a second feedback is received from the user, the present embodiment can apply the rating of the user to the second feedback received from the user.

### TECHNICAL FIELD

The present claimed invention relates to the field of user feedback. More particularly, the present claimed invention relates to prioritizing user feedback.

### BACKGROUND ART

Today, organizations use consumer feedback as an efficient way of keeping in touch with other businesses as well as individual users while also remaining in touch with the needs of the market. The consumer feedback may range from basic product registration postcards to in-depth beta analysis. In addition, many organizations utilizing the Internet have user interactions ranging from the more traditional types, such as on-line purchasing and directory services, to brokerage accounts and on-line auctions. These organizations utilizing the Internet also use consumer feedback to ensure that most users are able to access and utilize the desired electronic sites.

Typically, during the utilization of the services which are made available electronically (e.g., web sites, web pages, or the like) a user may uncover an error in the service. The extent or severity of the error may vary quite significantly. For example, a user may find a web site which has a misspelling or “typo.” This type of error may be regarded as a clerical or minor error. In another case, a user may find that selecting an option or a combination of options on the web page will result in the web site ceasing to function or “crash.” This type of error may be regarded as an important or major error.

In many cases, an electronic web page will have a portion of the page designated for user feedback. This user feedback may address errors within the site, comments or complements about the site, questions regarding information seen on the site, or any number of other feedback possibilities. In general, the feedback may be in the form of electronic mail (e-mail), regular mail, or voice. For example, a user may be able to select the phone number, the physical address, or the electronic address from the web page. Due to the number of users who may access the web page, the amount of feedback received for a large company may be extreme.

Although the Internet is stated as the first environment in which user feedback is generated, the user feedback may result from actual use of a manufactured device, software, or any other device or system which may be made by a manufacturer and utilized by a consumer. This may also include services provided by the manufacturer to the consumer.

One problem with such mass amounts of feedback is the categorizing of the feedback. In many cases, a first level of screening may be required to properly classify the feedback. For example, there may be a category for problems and compliments. In addition, a second level of screening may be required to further classify the first level. For example, the problem may need to be analyzed by the second level of screening to resolve user errors from manufactured errors.

Once the issues have been properly classified, each category is forwarded to a person in charge of resolving the issues. In some cases, the person in charge may receive many hundreds or even thousands of comments. For example, if the problems caused by manufacture (e.g., bad web site, software issues, typos, etc.) are forwarded to a technician who will address the issues, in some cases, the technician may receive many hundreds or even thousands of comments. Furthermore, the person in charge may receive hundreds or even thousands of comments regarding the same issue. For example, the technician may receive hundreds or even thousands of comments regarding the same issue or fault. Therefore, the technician's time is wasted resolving (or sorting through) the repetitive feedback.

This conventional method for receiving and categorizing user feedback is extremely inefficient and usually results in undue frustration for both the user formulating the feedback and the person in charge having to deal with the repetitive nature of the issues. In addition, this inefficiency may result in loss of consumer trust and reduced consumer purchasing thereby resulting in monetary loss for the consumer.

### DISCLOSURE OF THE INVENTION

The present invention provides, in various embodiments, a method and system for prioritizing user feedback. A method embodiment receives a first feedback from a user. This embodiment of the present invention then assigns a value of the first feedback. In addition, the present embodiment assigns a rating to the user based on the value of the first feedback. In so doing, when a second feedback is received from the user, the present embodiment can apply the rating of the user to the second feedback received from the user.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram depicting a system for organizing user feedback in accordance with one embodiment of the present invention.

FIG. 2 is a block diagram depicting a database organized based on the users rating in accordance with one embodiment of the present invention.

FIG. 3 is a flow chart of steps in a method for prioritizing user feedback in accordance with one embodiment of the present invention.

FIG. 4 is a block diagram of exemplary circuitry of a computing system that may be used as a platform to implement embodiments of the present invention.

The drawings referred to in this description should be understood as not being drawn to scale except if specifically noted.

### DESCRIPTION OF THE PREFERRED EMBODIMENTS

In the following detailed description of the present invention, a method and system for prioritizing user feedback, specific details are set forth in order to provide a thorough understanding of the present invention. However, it will be recognized by one skilled in the art that the present invention may be practiced without these specific details or with equivalents thereof. In other instances, well-known methods, procedures, components, and circuits have not been described in detail as not to unnecessarily obscure aspects of the present invention.

Some portions of the detailed descriptions that follow are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those that require physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

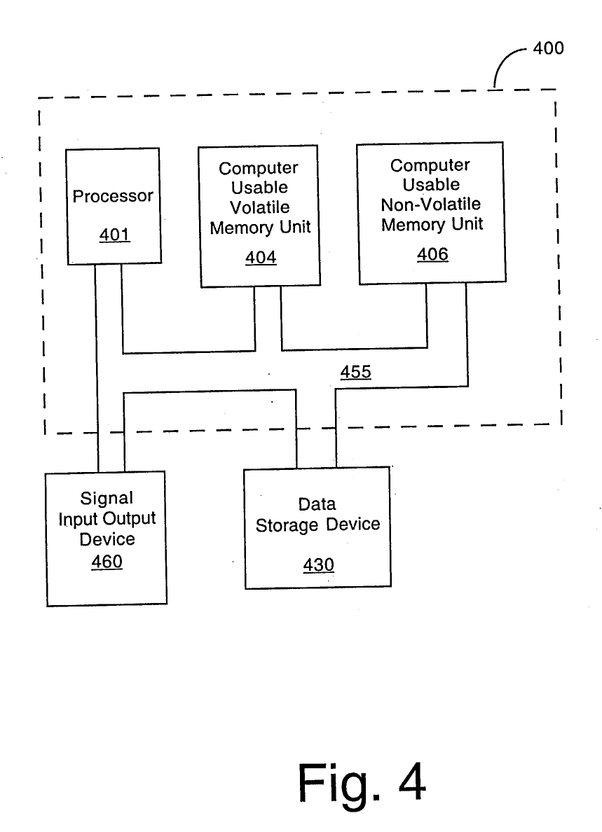

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving”, “transmitting”, “assigning”, “applying”, “organizing”, “processing” or the like, refer to the action and processes of a computer system (e.g., FIG. 4), or similar electronic computing device, that manipulates and transforms data represented as physical (electronic) quantities within the computer system's registers and memories into other data similarly represented as physical quantities within the computer system memories or registers or other such information storage, transmission or display devices.

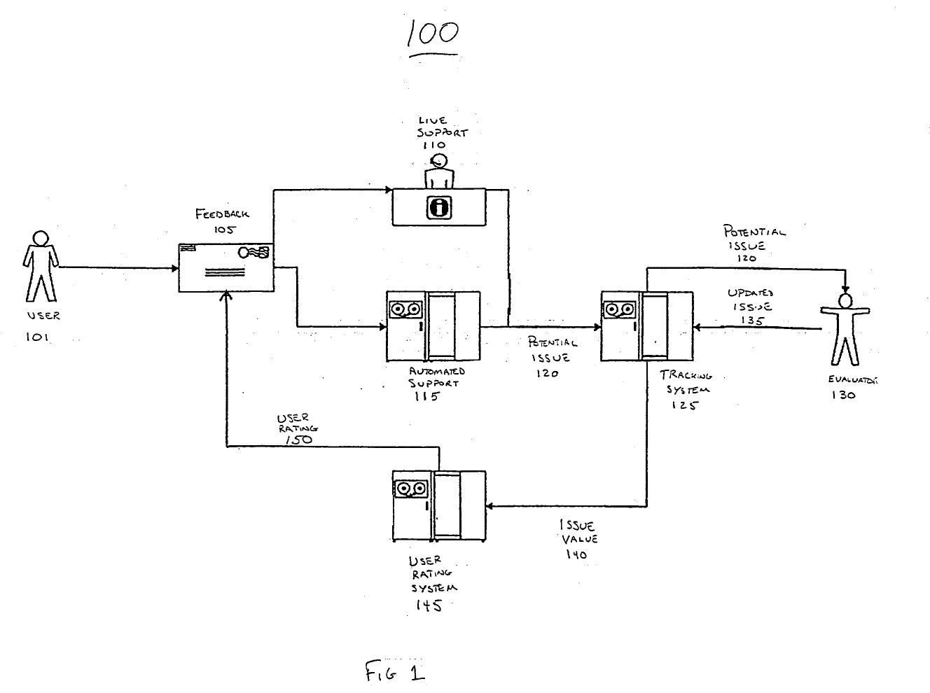

With reference now to FIG. 1, a system for organizing user feedback is shown in accordance with one embodiment of the present invention. System 100 includes a user 101, feedback 105, live support 110, automated support 115, potential issue 120, tracking system 125, evaluator 130, updated issue value 135, issue value 140, user rating system 145, and user rating 150. In one embodiment, the present invention described herein may be utilized to incorporate the value of feedback from users into the rating of the user. With this rating, the organization can tailor its response based on the user rating. For example, if a user has submitted high value feedback on a product or web site in the past, new feedback provided by the user could be processed with higher priority in anticipation of it also containing high value.

In one embodiment, user 101 may be a person using a product (e.g., software, a web site, any manufactured device, or the like) who supplies feedback 105 to the company. As stated herein, feedback 105 may be electronic feedback (e.g., e-mail, instant message, web site, quick link, or the like), vocal feedback (e.g., telephone call, or the like), or written feedback (e.g., regular mail, telegram, or the like). Feedback 105 may include defect information, product ideas, customer referrals, competitive information, or the like. Therefore, although many examples described herein describe the feedback as a defect, the present invention is well suited to the feedback being of any type that may have value to the company.

With reference still to FIG. 1, live support 110 may be utilized to answer feedback 105 if vocal feedback is received. Live support 110 may also be utilized with electronic and/or written feedback. However, automated support 115 may also be utilized with any form of feedback 105. In one embodiment, automated support may be a computing system similar to computing system 400. In addition, live support 110 and automated support 115 may be used in conjunction to better respond to the user feedback. For example, if user 101 calls and automated support 115 answers, user 101 may select to talk to live support 110. In another embodiment, as described in more detail herein, after automated support 115 receives the vocal feedback of user 101, automated support 115 may redirect user 101 to live support 110.

Once feedback 105 is initially passed through live support 110 and/or automated support 115, feedback 105 is forwarded to tracking system 125 as a potential issue 120. Tracking system 125 may be a computing system similar to computing system 400 and may be used as a database for storing and disseminating a plurality of potential issue's 120 to an evaluator 130. In one embodiment, evaluator 130 may be a technician responsible for resolving and/or evaluating potential issue 120. In another embodiment, evaluator 130 may be a computing system similar to computing system 400 responsible for resolving and/or evaluating potential issue 120. Once potential issue 120 is evaluated by evaluator 130, the updated issue may be returned to tracking system 125. Tracking system 125 may then assign an issue value 140 (e.g., the value of the feedback) to the user 101.

With reference still to FIG. 1, issue value 140 may be based on the value of the feedback. That is, issue value 140 may be based on the value of features and defects addressed by the feedback from the user. Thus, issue value 140 may be based upon the severity of the defect addressed. For example, a feedback 105 addressing a severe defect (e.g., virus, web site causing system crash, or the like) may receive a higher rating than a feedback 105 addressing a minor defect (e.g., a typo). The issue value 140 may also be based on the number of other feedbacks 105 which have already addressed the issue. For example, if feedback 105 is the first feedback to address a specific issue or flaw, then user 101 may receive a higher rating than if feedback 105 is the 50^{th} feedback to address a specific issue or flaw. It is also appreciated that the issue value 140 may be a combination of severity and the number of other feedbacks 105 addressing the issue.

In another embodiment, issue value 140 (and user rating 150) may be based on revenue generated from user 101 or a cooperative agreement with the user 101. For example, if user 101 is a high revenue generator for the company, an important client, or the like, system 100 may initially apply a high issue value 140 and user rating 150 based on user 101 instead of the actual value of the feedback 105.

The issue value 140 is then applied to the user rating system 145. In one embodiment, user rating system 145 may be a computing system similar to computing system 400. User rating system 145 then assigns a user rating 150 to user 101 based on the issue value 140 (and any previous issue values described in more detail herein). Thus, as described in more detail herein, the next time feedback 105 is received from user 101, the user rating 150 will be applied to the user feedback 105 before (or when) feedback 105 is received by either live support 110 and/or automated support 115.

User rating system 145 and tracking system 125 may be applications running on the same device. Furthermore, automated support 115, user rating system 145 and tracking system 125 may all be applications running on the same device.

For example, the system 100 for organizing user feedback may include a first device (e.g., live support 110 and/or automated support 115) to receive feedback 105 from a user 101. In addition, a second device (e.g., tracking system 125 and/or user rating system 145) may be used to assign a rating to the user based on the value of the feedback 105. Therefore, when any further feedback 105 is received from the user 101, the first device (e.g., live support 110 and/or automated support 115) may apply the rating 150 to the feedback 105.

In one embodiment, first device (e.g., live support 110 and/or automated support 115) may maintain a database of feedback 105 and prioritize the feedback 105 based on the user rating 150. For example, feedback 105 having a higher user rating 150 may be placed above feedback 105 having a lower user rating 150.

For example, a user 101 has a user rating 150 based on earlier interactions with the company. An element of this rating may be the value 140 of the comment submitted by the user. The user 101 may provide information (e.g., feedback 105), which may in one embodiment, contain a defect report, by using a web site, sending e-mail or regular mail, or calling the customer support center. The user information (e.g., feedback 105) is annotated with the user's rating 150 (if it is not the user's first feedback, if it is the user's first feedback no user rating 150 is assigned, or an average user rating 150 may be assigned, or any initial user rating 150 so designated by the company may be assigned). If the feedback 105 contains a potential defect, a user support person 110 or automated feedback forwarding system 115 submits a defect report (e.g., potential issue 120) to the defect tracking system 125. A quality or development engineer (e.g., evaluator 130) may evaluate the defect report and update it (e.g., updated issue 135) with information about the potential defect (e.g., real defect or not, severity, first report of the defect, or the like). The defect tracking system 125 may then forward the defect value 140 to the user rating system 145, where it is factored into the user's rating 150.

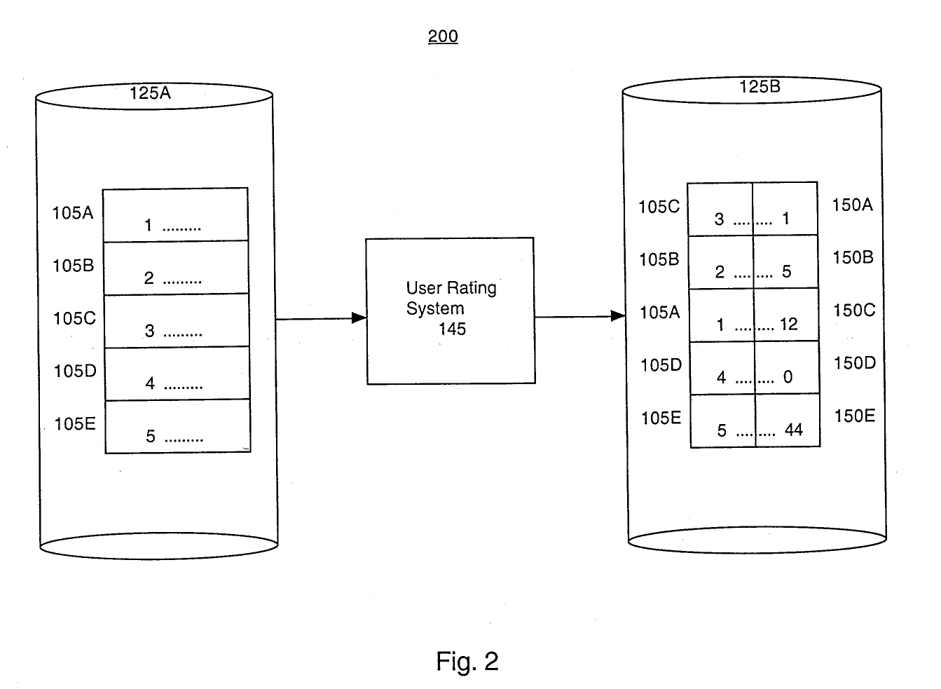

With reference now to FIG. 2, a block diagram depicting a database organized based on the user's rating is shown in accordance with one embodiment of the present invention. Specifically, a first database 125A is shown having user feedback (e.g., 105A through 105 E) in the order which they were received. The feedback within first database 125A is then amended by user rating system 145 to include the user rating 150. This results in the new database 125B (e.g., tracking system 125) which has the feedback (e.g., 105A through 105E) re-prioritized based on the user rating (e.g., 150A through 150E). Therefore, when an evaluator 130 accesses the database 125B to begin reviewing the feedback, the evaluator 130 receives the feedback in the re-prioritized order. For example, instead of evaluator receiving the feedback in the order of 105A, 105B, 105C, 105D, and 105E, evaluator 130 receives the feedback in the order 105C, 105B, 105A, 105D, and 105E. The order of the feedback re-prioritization shown in FIG. 2 is merely for purposes of clarity.

Although the databases 125A and 125B are shown with a reorganization of the feedback (e.g., 105A through 105E) the reorganization of databases 125B with respect to database 125A is not necessary. The order of the feedback may remain in any order within the database and a computing system such as tracking system 125 may select the feedback to be evaluated based not on location within the database but on another factor (e.g., user rating) within the database. In another embodiment, not all feedback within database 125B (of FIG. 2) may be evaluated. For example, a pre-designated minimum user rating 150 may be necessary for a specific feedback to be seen by evaluator 130. Therefore, if the minimum user feedback is established, then any feedback which does not obtain the minimum required user rating may be ignored, forwarded, re-routed, or the like.

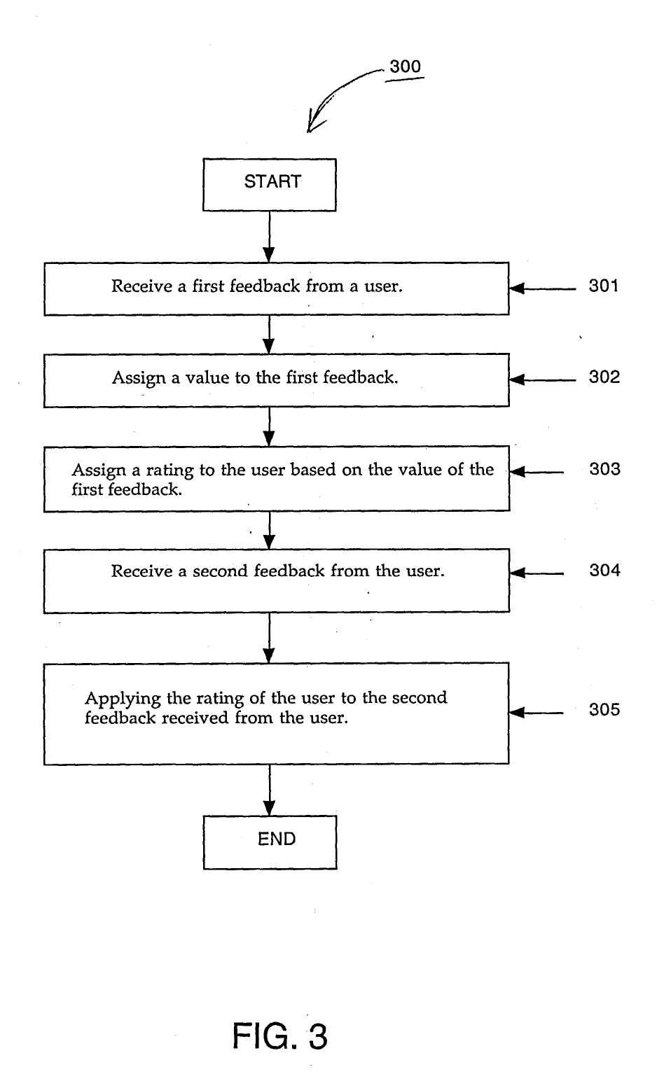

With reference now to FIG. 3, a flow chart of steps in a method for prioritizing user feedback is shown in accordance with one embodiment of the present invention. In many cases user ratings may not be applied to just feedback for error detection as described herein. In fact, a company may use the user ratings to provide different responses to different users based on their value to the company. For example, a company may provide different service based on the revenue generated from the user. In addition, with the quick pace of software development, it is very helpful to companies if they could identify the users that provided the most valuable feedback about product features as well as defects. Thus, if a report comes in from someone who has a history of excellent input, then the development team may want to review the feedback from that particular user as quickly as possible. Therefore, a higher priority user rating may be placed on that user.

Referring now to step 301 of FIG. 3 and FIG. 1, in one embodiment a first feedback is received from a user. As described herein, the first feedback 105 from user 101 may be received by live support 110 and/or automated support 115. Once first feedback 105 is initially received it may then become a potential issue 120 which is forwarded to tracking system 125. In general, no user rating 150 may be assigned to the first feedback 105 from user 101 due to no prior knowledge of feedback 105 from user 101. However, in one embodiment, a user 101 may have an initial user rating 150. For example, if the user 101 is an important client, the user 101 may receive an initial user rating 150 on any feedback 105 received from the user 101.

Also, a user 101 may have possible cross-rating from different business processes. That is, a user may be assigned a separate rating for each business process in which he/she participates. Some business processes may corroborate well with others and some may not. For example, a user may have an established rating from an application program developer website. If that user accesses a product support website for the first time, the application program for website rating may be relevant and may be applied to the first feedback to the product support website.

With reference still to step 301 of FIG. 3 and now to FIG. 2, in one embodiment, once feedback 105 reaches tracking system 125, the database of tracking system 125 may re-organize the order of the feedback 105 based on the user rating 150 (e.g., 150A through 150E), wherein feedback 105 having a higher user rating 150 is placed above feedback having a lower user rating 150. For example, feedback 105C is placed above feedback 105A in tracking system database 125B. Furthermore, if a feedback 105 has no user rating 150, tracking system 125B may have a standard default. For example, in one embodiment if feedback 105D has no user rating, it may remain in its place of order in the database. In another embodiment, tracking system database 125B may have a default which places a standard priority on feedback having no user rating 150. For example, only high priority user feedback may be placed above non-rated feedback. That is, a predetermined user rating 150 may be above a non-rated feedback 105 while any user rating 150 below that predetermined level will fall below the non-rated feedback 105. Thus, it is appreciated that, the organization of the non-rated feedback with respect to rated feedback may be prioritized as a company sees fit.

With reference now to step 302, of FIG. 3 and FIG. 1, in one embodiment a value is assigned to the feedback. For example, after potential issue 120 is received by tracking system 125 it is forwarded to an evaluator 130. Evaluator 130 then updates the potential issue 120. In one embodiment, evaluator 130 may assign a value to the potential issue 120. In another embodiment, the value may be assigned to potential issue 120 by tracking system 125 after the updated issue 135 is returned from evaluator 130.

With reference now to step 303 of FIG. 3 and FIG. 1, a rating is assigned to the user based on the value of the first feedback. For example, after the updated issue 135 receives an issue value 140 (e.g., assigned by evaluator 130 or tracking system 125) the issue value 140 is applied to user rating system 145. In general, user rating system 145 maintains a database of users 101. In one embodiment, the database of users 101 may be updated as an initial feedback 105 is received from a new user 101. In another embodiment, the database of users 101 may be initially programmed with a list of users 101 and their initial user rating 150. For example, if the user 101 is an important client, the user 101 may receive an initial user rating 150.

In one embodiment, the list of users in the user rating system 145 database may contain security features to prevent outside access to the user's identification. For example, if there are privacy concerns, the actual identity of the user may be protected by having the user rating system 145 use an encrypted identifier in the annotation rather than personally identifiable information.

Referring now to step 304 of FIG. 3 and FIG. 1, in one embodiment a second feedback is received from the user. As described herein, the second feedback 105 from user 101 may be received to live support 110 and/or automated support 115. Second feedback 105 may be electronic feedback (e.g., e-mail, instant message, web site, quick link, or the like), vocal feedback (e.g., telephone call, or the like), or written feedback (e.g., regular mail, telegram, or the like). Although a second feedback is stated, as described herein, the second feedback may be any number of feedback after the first feedback. For example, the second feedback may be any feedback from a user with an established user rating 150. The use of the term second feedback herein is merely for purposes of brevity and clarity.

With reference now to step 305 of FIG. 3 and FIG. 1, in one embodiment, once second feedback 105 is received a user rating 150 is assigned to the second feedback 105. After second feedback 105 receives the user rating 150 a plurality of possible actions may take place. If second feedback 105 is live feedback from user 101, then user support 110 and/or automated support 115 may interact differently with user 101 based on the user rating. For example, if the user rating 150 is low, that may suggest that user 101 is having the problem and may need individual technical assistance. However, if the user rating 150 is high, that may suggest that the user 101 has uncovered a serious issue and may need direct access to evaluator 130.

If the second feedback 105 is not live feedback from user 101, then user support 110 and/or automated support 115 may still interact differently with second feedback 105 based on the user rating 150. For example, if the user rating 150 is very high the feedback 105 may become a potential issue 120 and be forwarded to tracking system 125 without being reviewed by live support 110 and/or automated support 115. However, if the user rating 150 is low, the feedback 105 may be thoroughly reviewed by live support 110 and/or automated support 115 before it becomes a potential issue 120.

With reference still to step 305 of FIG. 3 and FIG. 2, in one embodiment, once second feedback 105 reaches tracking system 125, the database of tracking system 125 may re-organize the order of the second feedback 105 based on the user rating 150 (e.g., 150A through 150E), wherein feedback 105 having a higher user rating is placed above feedback having a lower user rating. For example, feedback 105C is placed above feedback 105A in tracking system database 125B. In one embodiment, after the value of the second feedback 105 is evaluated by evaluator 130 or tracking system 125, the user rating 150 may be updated based on the value of the second feedback. This update of user rating 150 may be an average type update, a completely new update based on the latest feedback value, a percentage of value of feedback versus time since each feedback has occurred, or any other type of statistical business method.

In addition to updating the user rating 150 based on further feedback, the user rating system 145 may also be utilized to apply a user rating 150 from one area to another. For example, if a user 101 has a high user rating 150 for fault-finding feedback, then if the same user 101 has a product idea feedback 105, the fault-finding user rating 150 may be applied to the product idea feedback 105. The extent to which a user rating from one area is applied to another may be based on a predicted statistical correlation between user feedback from the two areas. In yet another embodiment, the value of the fault-finding user rating 150 applied to the product idea feedback 105 may be dependent on whether the user rating is due to prior feedback or due to a pre-programmed user rating 150.

In another embodiment, if the user 101 has a user rating for both fault-finding and product idea feedback 105, then a ratio of the user rating 150 may be utilized to resolve the final user rating 150. In yet another embodiment, if the user 101 has a user rating for both fault-finding and product idea feedback 105, then the average of the user rating 150 may be utilized to resolve the final user rating 150. In another embodiment, if the user 101 has a user rating for both fault-finding and product idea feedback 105, then a predetermined equation of all data within user rating 150 may be utilized to resolve the final user rating 150. Therefore, it is appreciated that user rating 150 may be a single number as shown in 150A through 150E of FIG. 2, or user rating 150 may be a single number per category (e.g., fault-finding, product ides, or the like). If the user rating 150 is a single number per category, then there may be a plurality of statistical methods for manipulating the user rating 150 to be applied to feedback 105 depending on the situation.

FIG. 4 illustrates a block diagram of an exemplary computer system 400 used in accordance with embodiments of the present invention. System 400 of the present embodiment is well suited to be any type of computing device (e.g., server computer, portable computing device, desktop computer, etc.). Within the discussions of embodiments of the present invention, certain processes and steps are discussed that are realized, in one embodiment, as a series of instructions (e.g., software program) that reside within computer readable memory units of computer system 400 and executed by a processor(s) of system 400. When executed, the instructions cause computer 400 to perform specific actions and exhibit specific behavior that is described in detail herein.

Computer system 400 of FIG. 4 comprises an address/data bus 455 for communicating information, one or more central processors 401 coupled with bus 455 for processing information and instructions. Central processor unit(s) 401 may be a microprocessor or any other type of processor. The computer 400 also includes data storage features such as a computer usable volatile memory unit 404 (e.g., random access memory, static RAM, dynamic RAM, etc.) coupled with bus 455 for storing information and instructions for central processor(s) 401, a computer usable non-volatile memory unit 406 (e.g., read only memory, programmable ROM, flash memory, EPROM, EEPROM, etc.) coupled with bus 455 for storing static information and instructions for processor(s) 401. System 400 also includes one or more signal generating and receiving devices 460 coupled with bus 455 for enabling system 400 to interface with other electronic devices and computer systems. The communication interface(s) 460 of the present embodiment may include wired and/or wireless communication technology. For example, within the present embodiment, the communication interface 460 may be a serial communication port, a Universal Serial Bus (USB), an Ethernet adapter, a FireWire (IEEE 1394) interface, a parallel port, a small computer system interface (SCSI) bus interface, infrared (IR) communication port, Bluetooth wireless communication port, a broadband interface, or an interface to the Internet, among others.

The system 400 of FIG. 4 may also include one or more optional computer usable data storage devices 430 such as a magnetic or optical disk and disk drive (e.g., hard drive or floppy diskette) coupled with bus 455 for storing information and instructions.

Thus, the present invention provides, in various embodiments, a method and system for prioritizing user feedback. A method embodiment receives a first feedback from a user. This embodiment of the present invention then assigns a value of the first feedback. In addition, the present embodiment assigns a rating to the user based on the value of the first feedback. In so doing, when a second feedback is received from the user, the present embodiment can apply the rating of the user to the second feedback received from the user.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the claims appended hereto and their equivalents.

What is claimed is:

1. A method for prioritizing user feedback comprising:
receiving a first feedback from a user;
assigning a value to the first feedback;
assigning a rating to the user based on the value of the first feedback;
receiving a second feedback from the user; and
applying the rating of the user to the second feedback received from the user.

2. The method as recited in claim 1 further comprising:
organizing a database of feedback based on the user rating, wherein feedback having a higher user rating is assessed before feedback having a lower user rating.

3. The method as recited in claim 1 further comprising:
updating the user rating based on the value of the second feedback.

4. The method as recited in claim 1 wherein the first and second feedback from the user are electronic feedback, vocal feedback, or written feedback.

5. The method as recited in claim 1 wherein the value of the first feedback from the user is based on a value of features addressed by the feedback.

6. The method as recited in claim 1 wherein the value of the first feedback from the user is based on a value of defects addressed by the feedback.

7. The method as recited in claim 1 wherein the value of the first feedback from the user is based on the importance of the user to the company.

8. The method as recited in claim 7 wherein the importance of the user to the company is based on revenue generated from the user or a cooperative agreement with the user.

9. A system for organizing user feedback comprising:
a first device to receive a feedback from a user; and
a second device to assign a user rating based on a value of the feedback;
wherein the second device provides the user rating to the first device such that the first device is able to apply the user rating to any further feedback received from the user.

10. The system of claim 9 wherein the first device maintains a database of the feedback and prioritizes the feedback based on the user rating.

11. The system of claim 10 wherein feedback having a higher user rating is assessed before feedback having a lower user rating.

12. The system of claim 9 wherein the feedback from the user is electronic feedback, vocal feedback, or written feedback.

13. The system of claim 9 wherein the feedback from the user is selected from the group consisting of: a product idea, a customer referral, competitive information, and a product defect.

14. The system of claim 13 wherein the product defect feedback is a web site defect.

15. The system of claim 9 wherein the value of the feedback is based on the value of features and defects addressed by the feedback from the user.

16. The system of claim 9 wherein the value of the feedback is based on revenue generated from the user or a cooperative agreement with the user.

17. A computer system comprising:
a bus;
a memory unit coupled to said bus; and
a processor coupled to said bus, said processor for executing a method for organizing user feedback comprising:
a) receiving feedback from a user;
b) assigning a value to the feedback;
c) assigning a user rating based on the value of the feedback from the user; and
d) processing further feedback from the user based on the user rating.

18. The computer system of claim 17 wherein said a) of said method further comprises:
cataloging the feedback from the user in a hierarchical database.

19. The computer system of claim 18 further comprising:
e) re-organizing a hierarchical database of feedback based on the user rating applied to the feedback, wherein feedback having a higher user rating is assessed before feedback having a lower user rating.

20. The computer system of claim 17 wherein the feedback from the user is electronic feedback, vocal feedback, or written feedback.

21. The computer system of claim 17 wherein the value of the feedback from the user is based on the value of features and defects addressed by the feedback.

22. The computer system of claim 17 wherein the value of the feedback from the user is based on revenue generated from the user or a cooperative agreement with the user.

23. The computer system of claim 17 wherein the user rating for one type of feedback is applied to other types of feedback received from the user.
